(19) United States
(12) Patent Application Publication
(10) Pub. No.: US 2025/0310158 A1
(43) Pub. Date: Oct. 2, 2025

(54) FEEDFORWARD EQUALIZERS

(71) Applicants: Sashank Krishnamurthy, Hillsboro, OR (US); Mozhgan Mansuri, Portland, OR (US)

(72) Inventors: Sashank Krishnamurthy, Hillsboro, OR (US); Mozhgan Mansuri, Portland, OR (US)

(21) Appl. No.: 18/619,714

(22) Filed: Mar. 28, 2024

(51) Int. Cl. H04L 25/03; H04L 25/06

(52) U.S. Cl. CPC H04L 25/03878; H04L 25/03012; H04L 25/062

(57) ABSTRACT

A receiver apparatus includes front-end circuitry, feedforward equalizer (FFE) circuitry, and digital signal processor (DSP). The front-end circuitry is configured to convert an input signal into a digital signal. The FFE circuitry is coupled to the front-end circuitry and includes a first FFE circuit configured to generate a first equalized signal based on a pre-cursor signal associated with the digital signal. The FFE circuitry also includes a second FFE circuit cascaded with the first FFE circuit. The second FFE circuit generates a second equalized signal based on a post-cursor signal associated with the digital signal. The DSP generates an output signal based on at least one of the first equalized signal and the second equalized signal.

### BACKGROUND

The ever-growing demand for data centers and high-performance computing applications has driven the development of energy-efficient links with greater than 100 Gb/s per-lane data rate. Silicon photonics and vertical cavity surface emitting laser (VCSEL) based optical links are seen as potential candidates to replace electrical links for rack-to-rack connectivity in data centers with a range of tens to thousands of meters. While the use of optical fibers overcomes the loss of copper interconnects, the bandwidth limitations of the lasers and the photodiodes call for the use of equalization techniques to achieve these data rates.

### BRIEF DESCRIPTION OF THE DRAWINGS

In the drawings, like numerals may describe the same or similar components or features in different views. Like numerals having different letter suffixes may represent different instances of similar components. Some embodiments are illustrated by way of example, and not limitation, in the figures of the accompanying drawings in which:

FIG. 1 is a graph of an example input rectangular pulse and a graph of the pulse response due to a bandwidth-limited channel;

FIG. 2A is a block diagram of a resistively loaded current summing feedforward equalizer (FFE);

FIG. 2B is a block diagram of a Cherry-Hooper-based current summing FFE;

FIG. 3A is a diagram of a 2-tap quarter-rate pre-cursor FFE, in accordance with some embodiments;

FIG. 3B is a diagram of a sample and hold circuit and sampling clock signals used by the FFE of FIG. 3A, in accordance with some embodiments;

FIG. 3C is a timing diagram of the FFE of FIG. 3A, in accordance with some embodiments;

FIG. 4A is a diagram of a 2-tap quarter-rate post-cursor FFE, in accordance with some embodiments;

FIG. 4B is a diagram of a sample and hold circuit and sampling clock signals used by the FFE of FIG. 4A, in accordance with some embodiments;

FIG. 4C is a timing diagram of the FFE of FIG. 4A, in accordance with some embodiments;

FIG. 5A is a diagram of a 3-tap quarter-rate FFE with 1 pre-cursor and 1 post-cursor tap, using 25% duty-cycled clocks and their complementary phases, in accordance with some embodiments;

FIG. 5B is a diagram of a sample and hold circuit and sampling clock signals used by the FFE of FIG. 5A, in accordance with some embodiments;

FIG. 5C is a timing diagram of the FFE of FIG. 5A, in accordance with some embodiments;

FIG. 6A is a diagram of a 3-tap FFE using a cascade of a 2-tap pre-cursor FFE and a 2-tap post-cursor FFE, in accordance with some embodiments;

FIG. 6B is a diagram of a sample and hold circuit and sampling clock signals used by the FFE of FIG. 6A, in accordance with some embodiments;

FIG. 6C is a timing diagram of FFE slice 0 of the FFE of FIG. 6A, in accordance with some embodiments;

FIG. 6D is a timing diagram of FFE slice 270 of the FFE of FIG. 6A, in accordance with some embodiments;

FIG. 6E is a timing diagram of the FFE of FIG. 6A, in accordance with some embodiments;

FIG. 7A is a graph of unequalized 100 Gb/s PAM4 eye at a full rate associated with simulation results using the disclosed techniques;

FIG. 7B is a graph of unequalized 100 Gb/s PAM4 eye at a quarter rate associated with simulation results using the disclosed techniques;

FIG. 7C is a graph of equalized 100 Gb/s PAM4 eye at a quarter-rate with pre-cursor equalization [−0.13 1] associated with simulation results using the disclosed techniques;

FIG. 7D is a graph of equalized 100 Gb/s PAM4 eye at quarter-rate with post-cursor equalization [1 −0.15] associated with simulation results using the disclosed techniques;

FIG. 7E is a graph of equalized 100 Gb/s PAM4 output eye at quarter-rate with the 3-tap quarter-rate equalizer implemented as a cascade of the pre-cursor [−0.13 1] and post-cursor equalizer [1 −0.15] associated with simulation results using the disclosed techniques;

FIG. 8 is a diagram of (N+1)-tap post-cursor FFE using a cascade of N 2-tap post-cursor FFEs, in accordance with some embodiments;

FIG. 9 is a flow diagram of an example method for performing feedforward equalization, in accordance with some embodiments; and

FIG. 10 illustrates a block diagram of an example machine upon which any one or more of the operations/techniques (e.g., methodologies) discussed herein may perform.

### DETAILED DESCRIPTION

The following detailed description refers to the accompanying drawings. The same reference numbers may be used in different drawings to identify the same or similar elements. In the following description, for purposes of explanation and not limitation, specific details are set forth, such as particular structures, architectures, interfaces, techniques, etc., to provide a thorough understanding of the various aspects of various embodiments. However, it will be apparent to those skilled in the art having the benefit of the present disclosure that the various aspects of the various embodiments may be practiced in other examples that depart from these specific details. In certain instances, descriptions of well-known devices, circuits, and methods are omitted so as not to obscure the description of the various embodiments with unnecessary detail.

The following description and the drawings sufficiently illustrate specific embodiments to enable those skilled in the art to practice them. Other embodiments may incorporate structural, logical, electrical, process, and other changes. Portions and features of some embodiments may be included in or substituted for those of other embodiments. Embodiments outlined in the claims encompass all available equivalents of those claims.

As used herein, the term “chip” (or die) refers to a piece of a material, such as a semiconductor material, that includes a circuit, such as an integrated circuit or a part of an integrated circuit. The term “memory IP” indicates memory intellectual property. The terms “memory IP,” “memory device,” “memory chip,” and “memory” are interchangeable.

The term “a processor” configured to carry out specific operations includes both a single processor configured to carry out all of the operations (e.g., operations or methods disclosed herein) as well as multiple processors individually configured to carry out some or all of the operations (which may overlap) such that the combination of processors carry out all of the operations.

At the receiver (RX), decision feedback equalizers (DFEs) are widely used, but they typically are power-hungry and have stringent timing requirements to close the feedback loop at high data rates. RX multi-tap feedforward equalizers (FFEs) may be used to realize the links at data rates higher than 100 Gb/s, but these may pose challenges in clock generation and distribution due to the use of N-phase clocking with N being greater than 4 depending on the number of equalizer taps. The disclosed techniques include an RX quarter-rate multi-tap FFE, which can be realized as a cascade of multiple quarter-rate two-tap feedforward equalizers, each of which requires at most 4 clock phases at a quarter rate. The disclosed techniques also use inverter-based Cherry-Hooper feedforward equalizers to achieve higher bandwidth. Such feedforward equalizer techniques may also be used to equalize conventional wireline copper interconnects and wireless channels.

In some aspects, mixed-signal equalizers consist of summing the currents from the cursor and other taps and converting this current to a voltage through a resistor. However, the bandwidth of current-summing equalizers with a resistive load is limited by the RC time constant at the output node. The larger the number of taps, the lower the bandwidth and, hence, the effectiveness of the RX FFE. Additionally, the common mode DC operating point of the output is a function of the tap strengths, which is undesirable and needs to be corrected as it otherwise degrades the performance of following comparators (such as strong-arm latch) and also degrades the performance of the equalizer itself.

In some aspects, implementations of multi-tap equalizers use N-phase sub-rate clocks, where N can be a high number depending on the number of equalizer taps. However, quarter-rate quadrature clocks with 50% duty-cycle limit the number of taps to at most two. Implementation of a three-tap equalizer at quarter-rate needs 25% duty-cycled clocks, which are not easy to generate at high data rates. The alternative solution of a higher number of clock phases at lower frequencies imposes a power penalty for generating and distributing the clocks.

In some aspects, other implementations involve using multiple analog delays of 1 unit interval (UI) to implement multiple taps. However, the implementation of precise 1 UI analog delays, as well as tunable delays to support different data rates, is challenging at higher data rates.

The disclosed techniques can be used to configure an FFE based on an inverter-based Cherry Hooper amplifier, which is a transconductance current-summing stage in cascade with a shunt-feedback trans-impedance amplifier (TIA). The use of inverters ensures that the DC operating point is independent of the tap strengths, and the shunt-feedback TIA broadens the bandwidth. The disclosed N-tap quarter-rate equalizer can be implemented through the cascade of (N−1) two-tap equalizers, each of which can be implemented using quadrature 50% duty-cycled clocks in a quarter-rate RX. The improved bandwidth of the disclosed Cherry-Hooper-based FFE enables the operation of optical links at more than 50 GS/s/channel (50 Gb/s NRZ or 100 Gb/s PAM4). Additionally, the use of quadrature 50% duty-cycled clocks for implementing an N-tap equalizer (for a high N) using the disclosed techniques simplifies the clock generation and distribution.

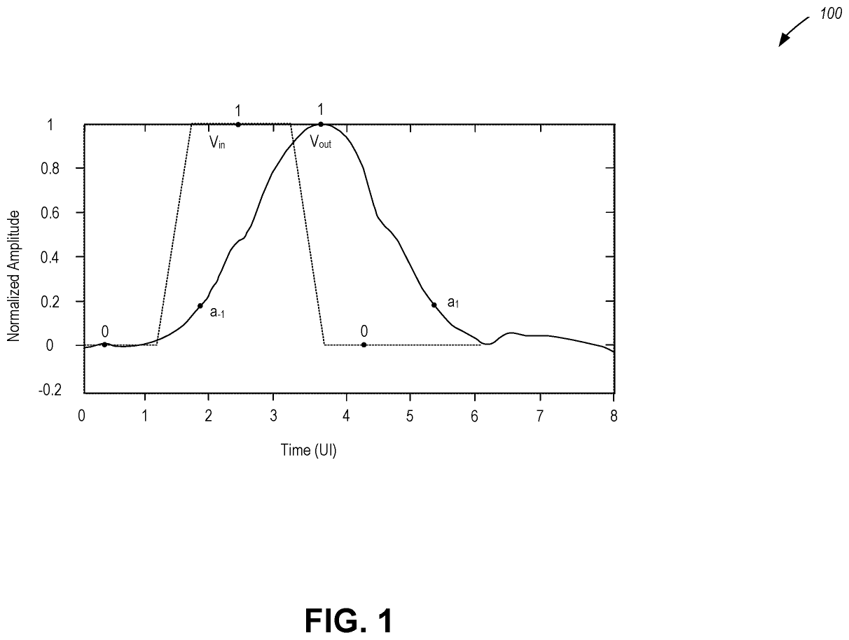

FIG. 1 is a graph 100 of an example input rectangular pulse and a graph of the pulse response due to a bandwidth-limited channel. More specifically, FIG. 1 shows an example of a pulse response in a bandwidth-limited channel, such as a wireline/wireless channel, or due to a bandwidth-limited optical device and/or analog front-end circuit. When this pulse response is sampled at the data rate, it is seen that while there is a peak cursor (normalized strength of 1) that is sampled, there is also a pre-cursor (a−1) and post-cursor (a1) one UI away. The pre-cursor shows how much the current bit affects the response of the previous bit or, conversely, how much the response of the current bit is affected by the next bit. Likewise, the post-cursor shows how much the current bit affects the response of the next bit or, conversely, how much the response of the current bit is affected by the previous bit.

The channel response in the z-domain is given by H(z)=a₋₁z+1+a₁z⁻¹. In the time domain, this means that the output vₒᵤₜ[n] (due to the current bit vᵢₙ[n]) is given by a₋₁vᵢₙ[n+1]+vᵢₙ[n]+a₁vᵢₙ[n−1]. If the previous and next bits vᵢₙ[n−1] and vᵢₙ[n+1] are of opposite polarity as the current bit vᵢₙ[n], the strength of the output is reduced to 1−a₋₁−a₁. A three-tap equalizer of the form H_{eq}(z)=−a₋₁z+1−a₁z⁻¹ helps mitigate the impact of this inter-symbol interference caused by the bandwidth-limited channel. An equalizer with a higher number of taps (e.g., as disclosed herein) can be associated with increased compensation for the bandwidth.

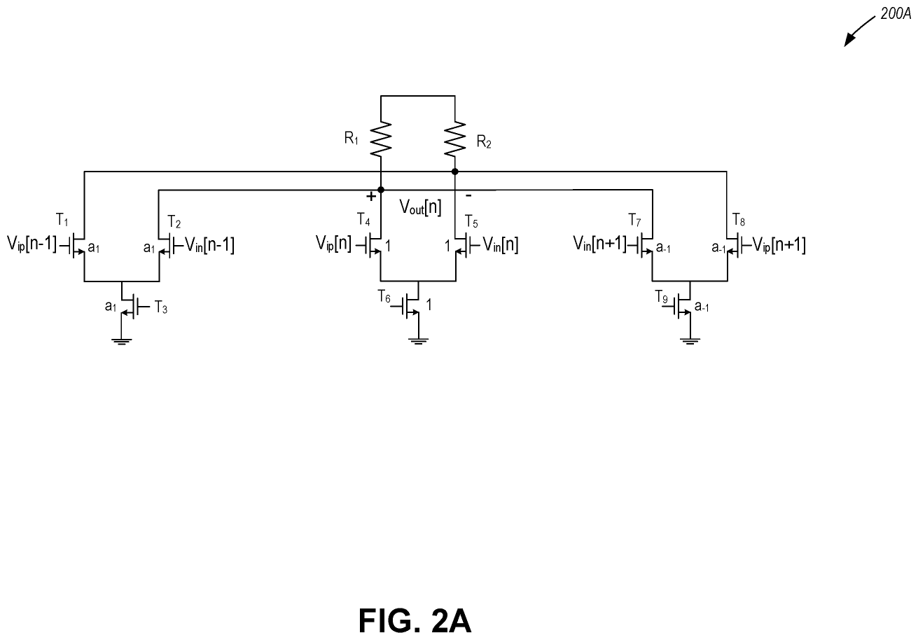

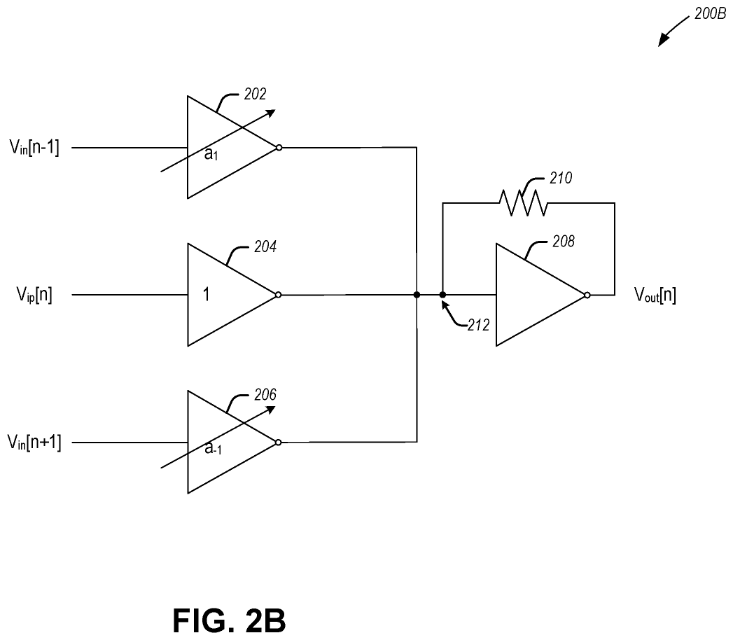

FIG. 2A is a block diagram of a resistively loaded current summing feedforward equalizer (FFE) 200A. Referring to FIG. 2A, FFE 200A can be configured using transistors T1, T2, T3, T4, T5, T6, T7, T8, and T9, as well as resistors R1 and R2, connected as illustrated in FIG. 2A.

FIG. 2B is a block diagram of a Cherry-Hooper-based current summing FFE 200B. Referring to FIG. 2B, FFE 200B can be configured using inverters 202, 204, and 206 (to process/amplify a sampled pre-cursor signal, a sampled cursor signal, and a sampled post-cursor signal, respectively). FFE 200B further includes inverter 208 coupled to resistor 210, with inverter 208 generating the output voltage signal vₒᵤₜ based on the input voltage signals received by inverters 202-206.

In some aspects, a three-tap equalizer H_{eq}(z)=−a₋₁z+1−a₁z⁻¹ can be configured to equalize for a channel H_{ch}(z) of the form a₋₁z+1+a₁z⁻¹, and then subsequently generalize this to the implementation of an N-tap equalizer. An implementation of this equalizer can include summing the currents from the cursor and other taps using differential pairs (e.g., as illustrated in FIG. 2A) and converting this current to a voltage through a resistor. The bandwidth of current-summing equalizers with a resistive load is limited by the RC time constant at the output node. Also, the common mode DC operating point of the output is a function of the tap strengths of the various FFE taps, requiring offset correction circuits (DCOC) to correct for the DC common mode depending on the tap strength. Such circuits add to the loading of the output node and degrade performance.

In this regard, the disclosed techniques include a Cherry-Hooper-based current summing FFE with inverters. In the representative 3-tap FFE example shown in FIG. 2B, the cursor, pre-cursor, and post-cursor signals are converted to currents by an inverter-based transconductance stage with appropriate weights. The currents are summed and converted into a voltage using a trans-impedance amplifier (formed by inverter 208 and resistor 210). The use of the shunt-feedback trans-impedance stage in the Cherry Hooper FFE enhances the bandwidth, enabling higher speeds. The use of inverters keeps the output DC common mode constant across tap strengths without the need for DCOC. The tap strengths are tuned by digital tuning of inverter sizes used in the transconductance stage.

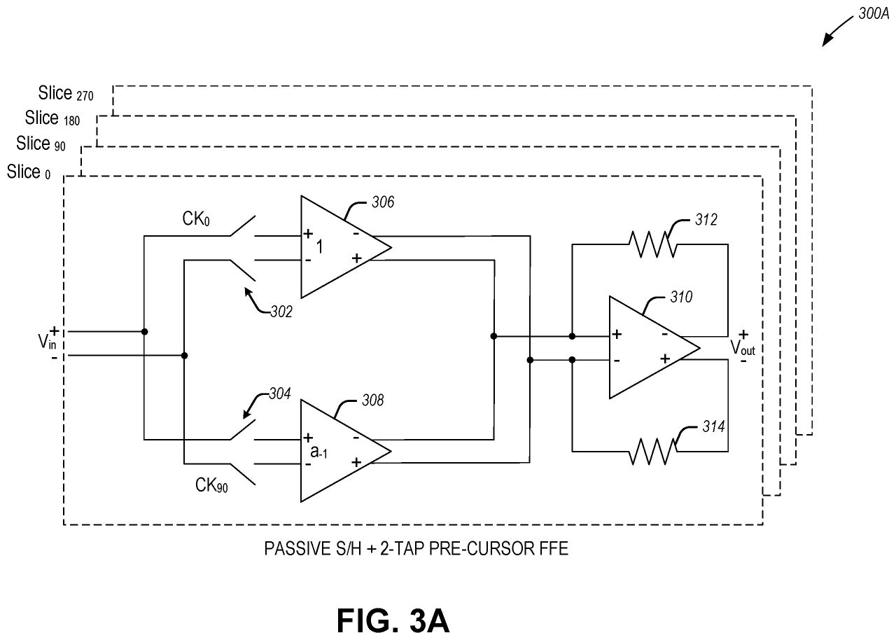

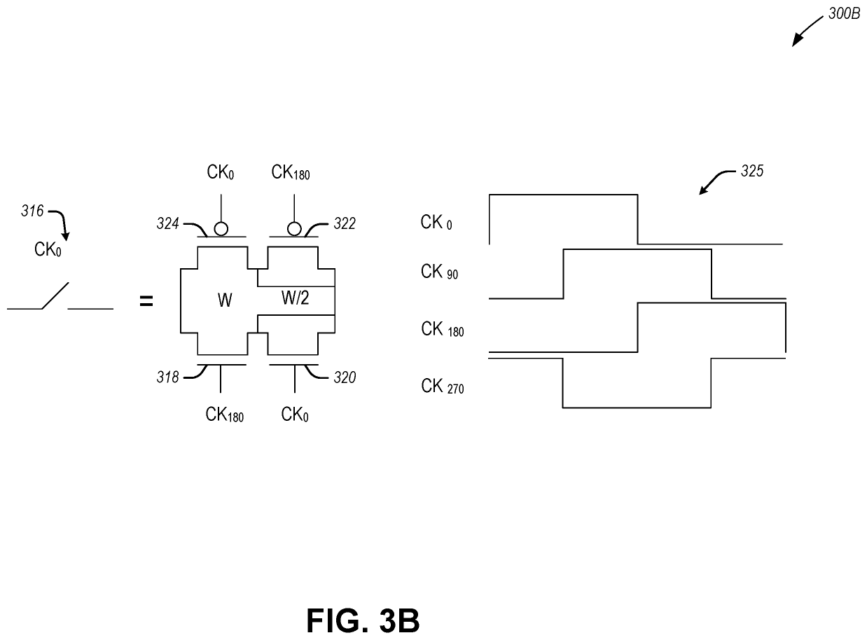

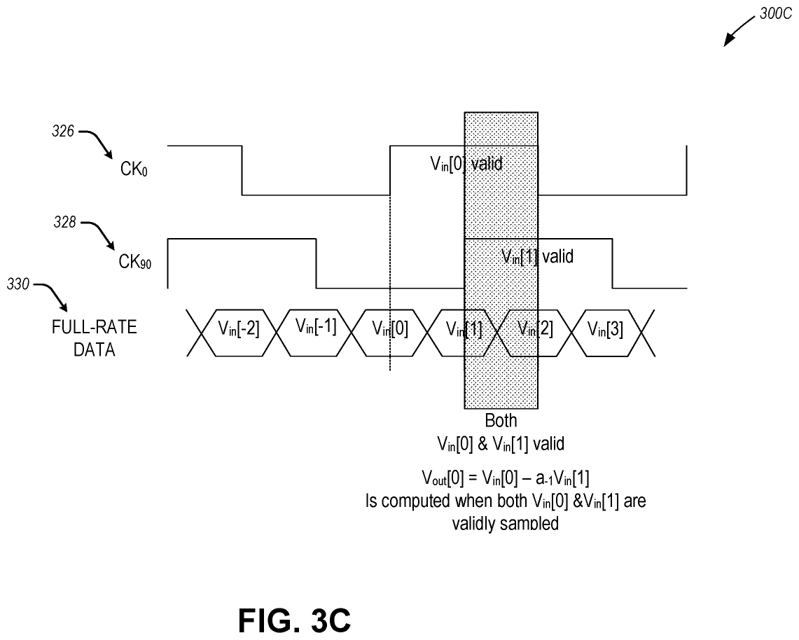

The disclosed techniques further include sampling the cursor, pre-cursors, and post-cursor signals. FIGS. 3A-3C show a representative example of a 2-tap quarter-rate pre-cursor equalizer.

FIG. 3A is a diagram of a 2-tap quarter-rate pre-cursor FFE 300A, in accordance with some embodiments. Referring to FIG. 3A, FFE 300A includes four FFE slices, referenced in FIG. 3A as slice 0, slice 90, slice 180, and slice 270. Slice 0 includes a first set of sample and hold circuits 302 coupled to a differential inverter 306 and a second set of sample and hold circuits 304 coupled to a differential inverter 308. The outputs of the differential inverters 306 and 308 are provided as inputs to differential inverter 310, which is also coupled to resistors 312 and 314. A differential input voltage signal Vin is provided as input to the first set of sample and hold circuits 302 and the second set of sample and hold circuits 304, with the differential inverter 310 generating a corresponding output voltage signal Vout.

In some aspects, slice 90, slice 180, and slice 270 have the same configuration (components) as slice 0. However, each of the slices can be configured to sample at different times based on different clock signals. For example, FFE 300A can use clock signals CK0, CK90, CK180, and CK270, which can be four clock signals that are a quarter period offset from each other (e.g., one clock signal is a quarter period, or 90 degrees, offset from a neighboring clock signal). In some aspects, slice 0, slice 90, slice 180, and slice 270 are clocked by pairs of clock signals that are a quarter-period offset from each other. For example, slice 0 is clocked by CK0 and CK90 (e.g., as illustrated in FIG. 3A), slice 90 can be clocked by CK90 and CK180, slice 180 can be clocked by CK 180 and CK270, and slice 270 can be clocked by CK270, and CK0.

FIG. 3B is a diagram of a sample and hold circuit 316 and sampling clock signals 325 used by the FFE of FIG. 3A, in accordance with some embodiments. Referring to FIG. 3B, sample and hold circuit 316 can be used in the first set of sample and hold circuits 302 (e.g., the first set of sample and hold circuits 302 can include two of the sample and hold circuit 316) and can include PMOS transistors 324 and 322 as well as NMOS transistors 318 and 320, which are all coupled, as illustrated in FIG. 3B. A similar configuration of the second set of sample and hold circuits 304 can be used (e.g., based on sample and hold circuits similar to sample and hold circuit 316 but clocked with CK90 instead of CK0.

FIG. 3C is a timing diagram 300C of the FFE of FIG. 3A, in accordance with some embodiments. In some aspects, FFE 300A uses CK0 based on timing diagram 326, CK90 based on timing diagram 328, and full-rate input data to be sampled based on timing diagram 330. As illustrated in FIG. 3C, both Vin[0] and Vin[1] are valid when both CK0 and CK90 are high. Additionally, Vout[0]=Vin[0]−a−1Vin[1] is computed when both Vin[0] and Vin[1] are validly sampled.

As mentioned above, FFE 300A uses four clock phases, each at a quarter of the full data rate. In slice 0, the current bit (“cursor”) is sampled at the rising edge of CK₀ and held for 2 UIs, the next bit (“pre-cursor”) is sampled at the rising edge of CK₉₀ and held for 2 UIs. For 1 UI, when both the current bit and the next bit are valid, the equalized output mitigates the effect of the next bit on the current bit, that is, it performs pre-cursor equalization. The same explanation holds for the other three slices as well.

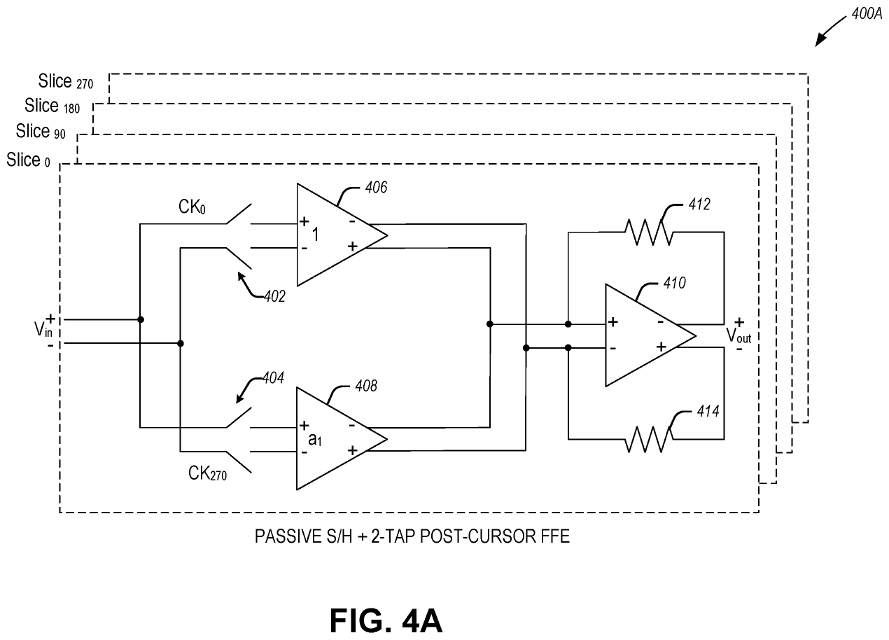

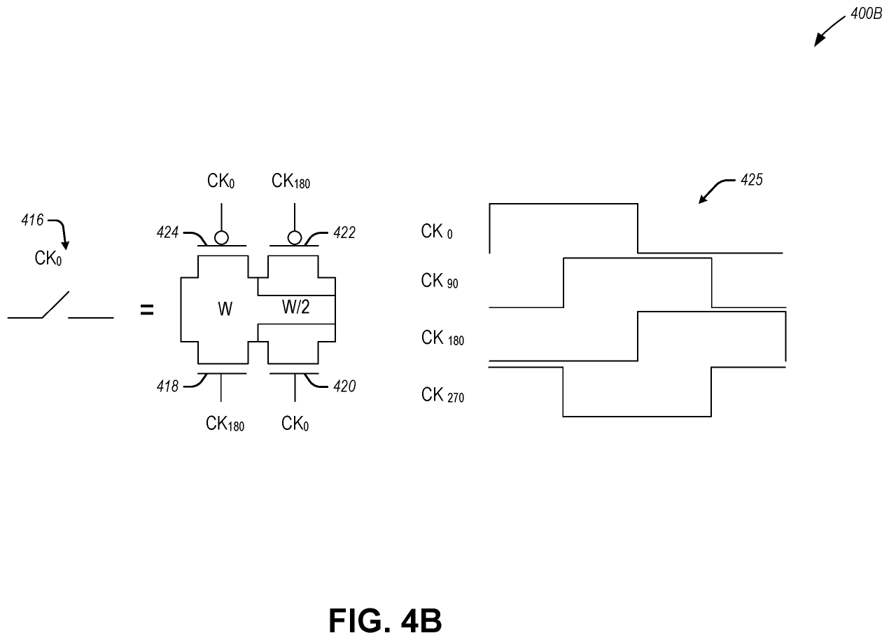

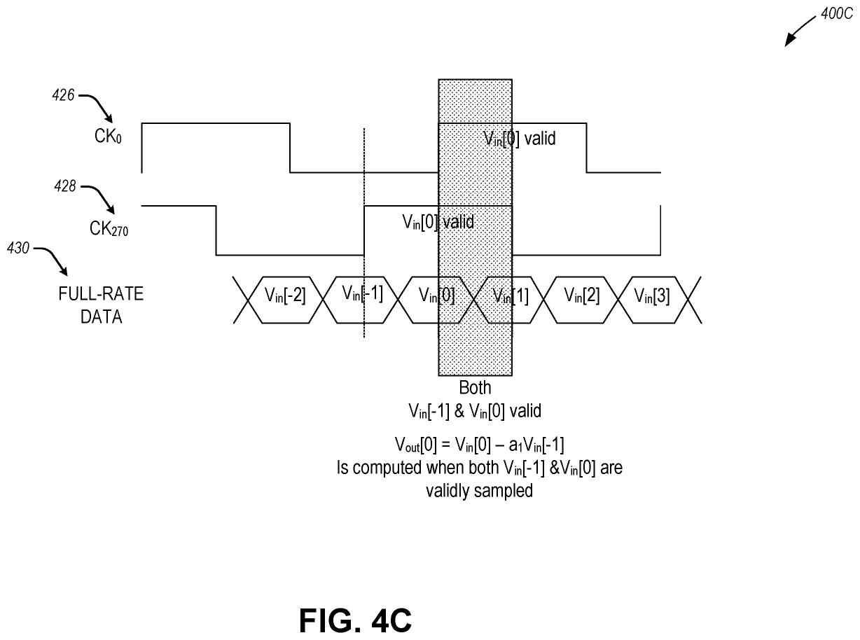

FIG. 4A is a diagram of a 2-tap quarter-rate post-cursor FFE 400A, in accordance with some embodiments. Referring to FIG. 3A, FFE 400A includes four FFE slices, referenced in FIG. 4A as slice 0, slice 90, slice 180, and slice 270. Slice 0 includes a first set of sample and hold circuits 402 coupled to a differential inverter 406 and a second set of sample and hold circuits 404 coupled to a differential inverter 408. The outputs of the differential inverters 406 and 408 are provided as inputs to differential inverter 410, which is also coupled to resistors 412 and 414. A differential input voltage signal Vin is provided as input to the first set of sample and hold circuits 402 and the second set of sample and hold circuits 404, with the differential inverter 410 generating a corresponding output voltage signal Vout.

In some aspects, slice 90, slice 180, and slice 270 have the same configuration (components) as slice 0. However, each of the slices can be configured to sample at different times based on different clock signals. For example, FFE 400A can use clock signals CK0, CK90, CK180, and CK270, which can be four clock signals that are a quarter period offset from each other (e.g., one clock signal is a quarter period, or 90 degrees, offset from a neighboring clock signal). In some aspects, slice 0, slice 90, slice 180, and slice 270 are clocked by pairs of clock signals that are a quarter-period offset from each other. For example, slice 0 is clocked by CK0 and CK270 (e.g., as illustrated in FIG. 4A).

FIG. 4B is a diagram of a sample and hold circuit 416 and sampling clock signals 425 used by the FFE of FIG. 4A, in accordance with some embodiments. Referring to FIG. 4B, sample and hold circuit 416 can be used in the first set of sample and hold circuits 402 and can include PMOS transistors 424 and 422 as well as NMOS transistors 418 and 420, which are all coupled, as illustrated in FIG. 4B.

FIG. 4C is a timing diagram 400C of the FFE of FIG. 4A, in accordance with some embodiments. In some aspects, FFE 400A uses CK0 based on timing diagram 426, CK270 based on timing diagram 428, and full-rate data sampling based on timing diagram 430. As illustrated in FIG. 4C, both Vin[−1] and Vin[0] are valid when both CK0 and CK270 are high. Additionally, Vout[0]=Vin[0]−a1Vin[−1] is computed when both Vin[−1] and Vin[0] are validly sampled.

FIGS. 4A-4C show a representative example of a 2-tap quarter-rate post-cursor equalizer (e.g., FFE 400A). Four clock phases, at a quarter of the full data rate, are used. In slice 0, the current bit (“cursor”) is sampled at the rising edge of CK0 and held for 2 UIs, the previous bit (“post-cursor”) is sampled at the rising edge of CK270 and held for 2 UIs. For 1 UI, when both the current bit and the previous bit are valid, the equalized output mitigates the effect of the previous bit on the current bit, that is, it performs post-cursor equalization. The same explanation holds for the other three slices as well.

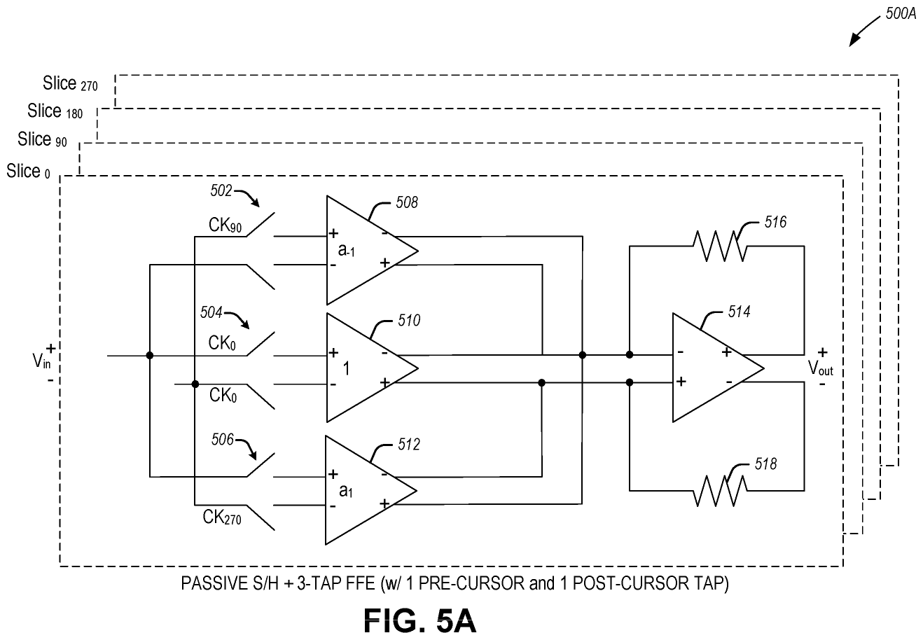

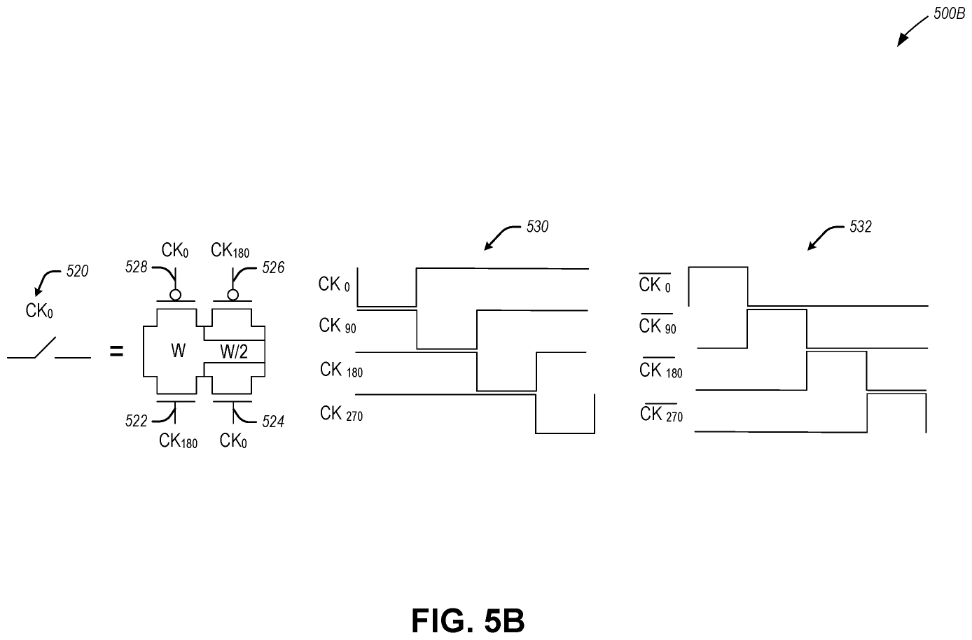

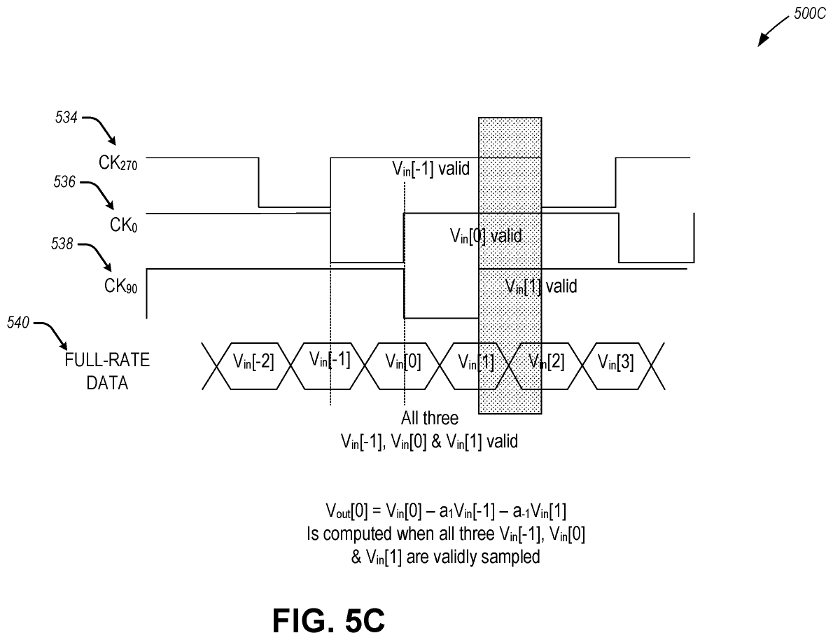

In some aspects, to implement a 3-tap FFE, the input samples can be held for 3UIs. This may be done by using a 25% duty-cycled 4-phase quarter-rate clock, which can be challenging to generate for symbol rates higher than 50 GS/s. The complementary version of the 25% duty-cycled clock is also required if the sampling switches consist of both NMOS and PMOS switches. An example implementation is illustrated in FIGS. 5A-5C. Alternately, 50% duty-cycled one-sixth rate clocks may be used at the cost of generating 6 clock phases. Instead, the FFE configurations of FIGS. 5A-5C are based on 25% duty-cycled quarter rate clocks.

FIG. 5A is a diagram of a 3-tap quarter-rate FFE 500A with 1 pre-cursor and 1 post-cursor tap, using 25% duty-cycled clocks and their complementary phases, in accordance with some embodiments. Referring to FIG. 5A, FFE 500A includes four FFE slices, referenced in FIG. 5A as slice 0, slice 90, slice 180, and slice 270. Slice 0 includes a first set of sample and hold circuits 502 coupled to a differential inverter 508, a second set of sample and hold circuits 504 coupled to a differential inverter 510, and a third set of sample and hold circuits 506 coupled to a differential inverter 512. The outputs of the differential inverters 508, 510, and 512 are provided as inputs to differential inverter 514, which is also coupled to resistors 516 and 518. A differential input voltage signal Vin is provided as input to the first set of sample and hold circuits 502, the second set of sample and hold circuits 504, and the third set of sample and hold circuits 506, with the differential inverter 514 generating a corresponding output voltage signal Vout.

In some aspects, slice 90, slice 180, and slice 270 have the same configuration (components) as slice 0. However, each of the slices can be configured to sample at different times based on different clock signals. For example, FFE 500A can use clock signals CK0, CK90, CK180, and CK270, which can be four clock signals that are a quarter period offset from each other (e.g., one clock signal is a quarter period, or 90 degrees, offset from a neighboring clock signal). In some aspects, slice 0, slice 90, slice 180, and slice 270 are clocked by clock signals that are a quarter-period offset from each other. For example, slice 0 is clocked by CK0, CK90, and CK270 (e.g., as illustrated in FIG. 5A).

FIG. 5B is a diagram of a sample and hold circuit 520 and sampling clock signals 530 and 532 used by the FFE of FIG. 5A, in accordance with some embodiments. Referring to FIG. 5B, sample and hold circuit 520 can be used in the second set of sample and hold circuits 504 and can include PMOS transistors 528 and 526 as well as NMOS transistors 522 and 524, which are all coupled as illustrated in FIG. 5B.

FIG. 5C is a timing diagram 500C of the FFE of FIG. 5A, in accordance with some embodiments. In some aspects, FFE 500A uses CK270 based on timing diagram 534, CK0 based on timing diagram 536, CK90 based on timing diagram 538, and full-rate data sampling based on timing diagram 540. As illustrated in FIG. 5C, Vin[−1], Vin[0], and Vin[1] are valid when CK0, CK90, and CK270 are high. Additionally, Vout[0]=Vin[0]−a₁Vin[−1]−a₋₁Vin[1] is computed when Vin[−1], Vin[0], and Vin[1] are validly sampled.

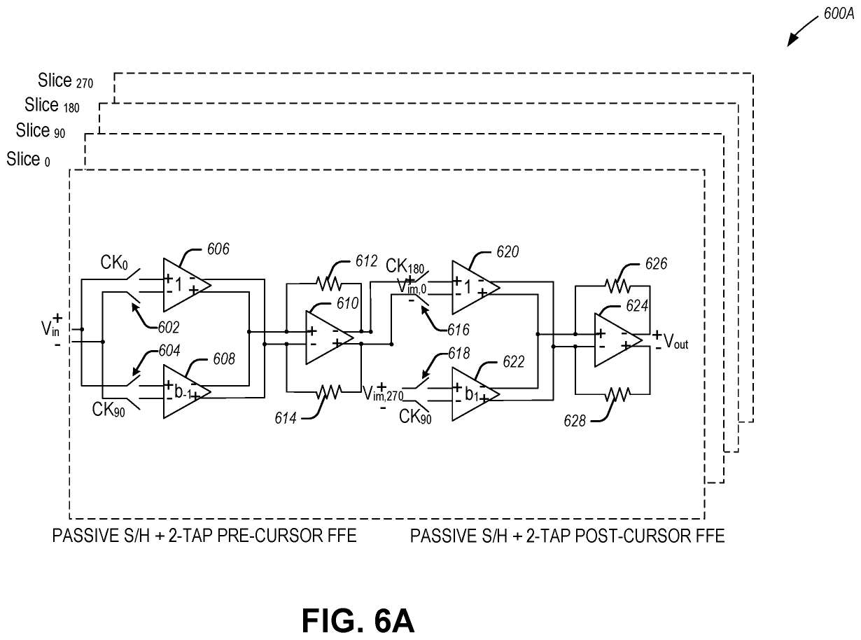

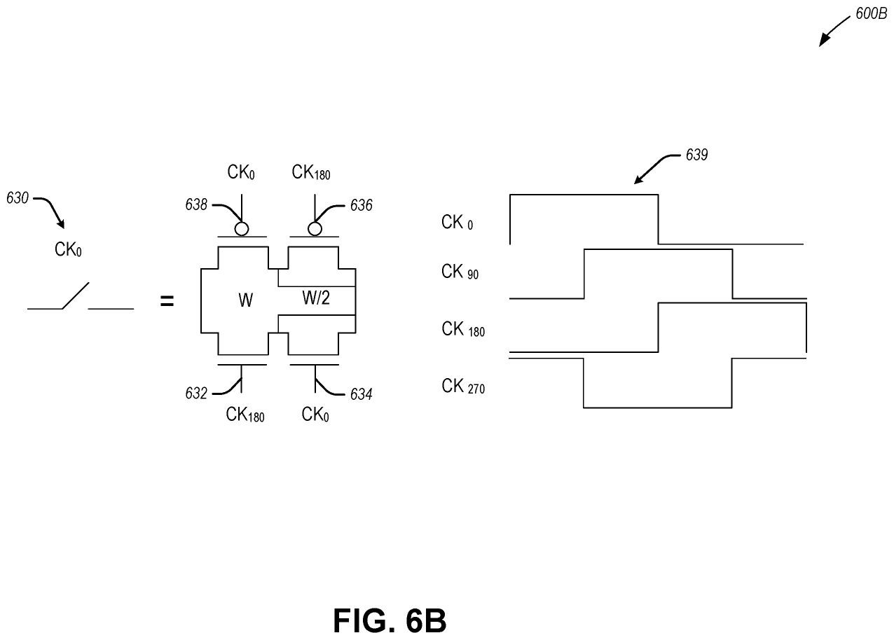

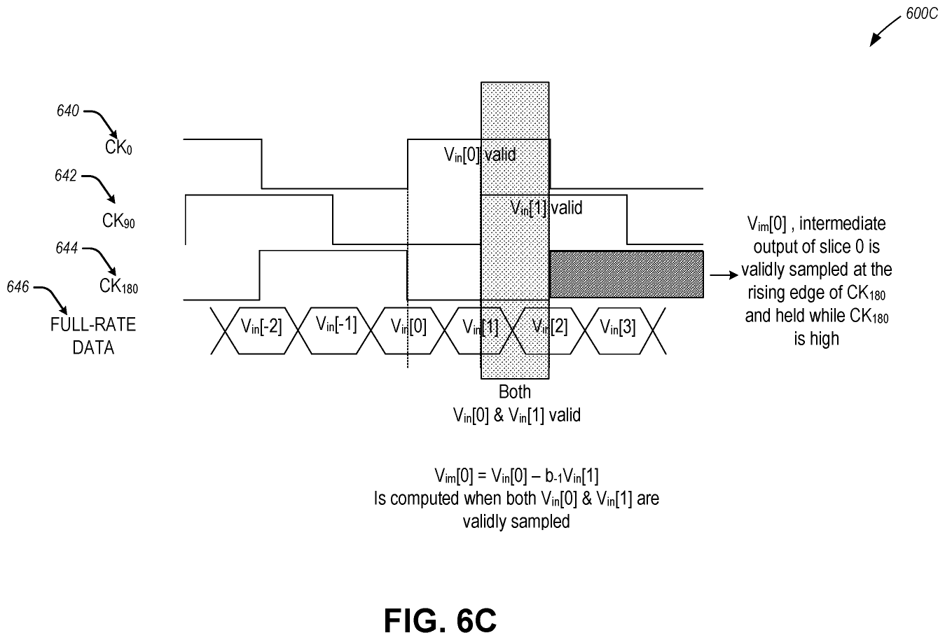

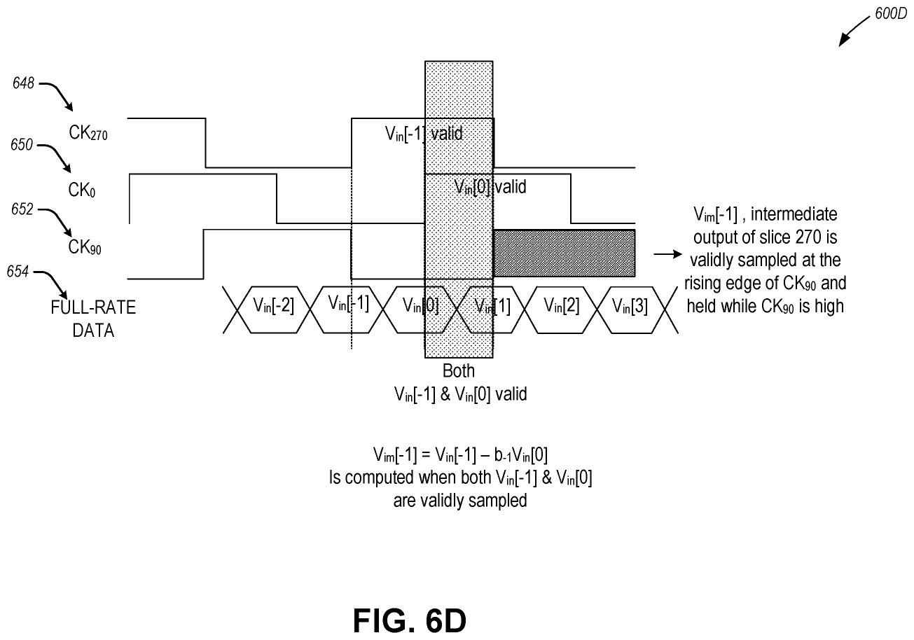

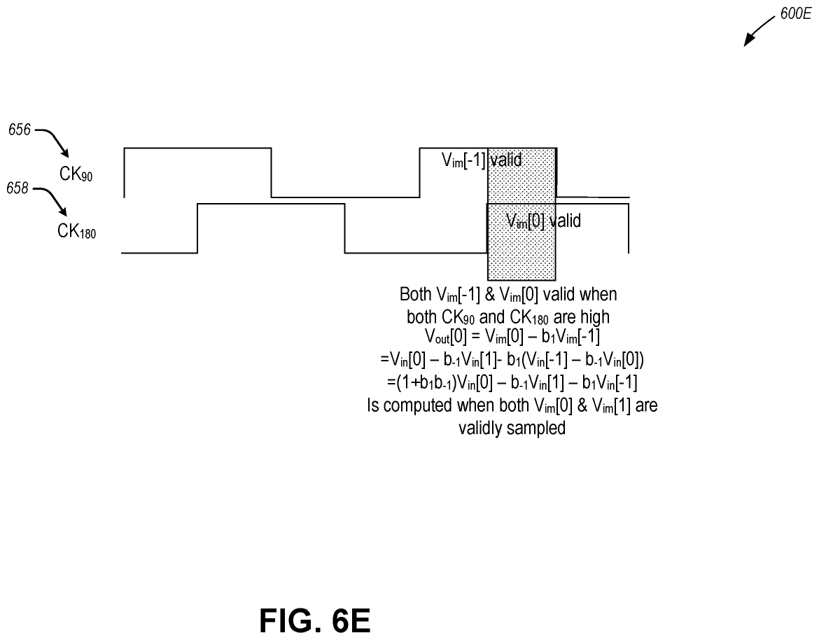

FIG. 6A is a diagram of a 3-tap FFE 600A using a cascade of a 2-tap pre-cursor FFE and a 2-tap post-cursor FFE, in accordance with some embodiments. Referring to FIG. 6A, FFE 600A includes four FFE slices, referenced in FIG. 6A as slice 0, slice 90, slice 180, and slice 270. Slice 0 includes a 2-tap pre-cursor FFE and a 2-tap post-cursor FFE. The 2-tap pre-cursor FFE is represented by a first set of sample and hold circuits 602 coupled to a differential inverter 606, a second set of sample and hold circuits 604 coupled to a differential inverter 608, and differential inverter 610 coupled to resistors 612 and 614. The 2-tap post-cursor FFE is represented by a third set of sample and hold circuits 616 coupled to a differential inverter 620, a fourth set of sample and hold circuits 618 coupled to a differential inverter 622, and differential inverter 624 coupled to resistors 626 and 628. As illustrated in FIG. 6A, the third set of sample and hold circuits 616 receives as input the output voltage signals from differential inverter 610, and the fourth set of sample and hold circuits 618 receives as input the output voltage signals of the pre-cursor FFE of slice 270.

In some aspects, slice 90, slice 180, and slice 270 of FFE 600A have the same configuration (components) as slice 0. However, each of the slices can be configured to sample at different times based on different clock signals. For example, FFE 600A can use clock signals CK0, CK90, CK180, and CK270, which can be four clock signals that are a quarter period offset from each other (e.g., one clock signal is a quarter period, or 90 degrees, offset from a neighboring clock signal). In some aspects, slice 0, slice 90, slice 180, and slice 270 are clocked by clock signals that are a quarter-period offset from each other. For example, the pre-cursor FFE in slice 0 is clocked by CK0 and CK90, and the post-cursor FFE in slice 0 is clocked by CK180 and CK90 (e.g., as illustrated in FIG. 6A).

FIG. 6B is a diagram of a sample and hold circuit 630 and sampling clock signals 639 used by the FFE of FIG. 6A, in accordance with some embodiments. Referring to FIG. 6B, sample and hold circuit 630 can be used in the first set of sample and hold circuits 602 and can include PMOS transistors 638 and 636 as well as NMOS transistors 632 and 634, which are all coupled as illustrated in FIG. 6B.

FIG. 6C is a timing diagram 600C of FFE slice 0 of the FFE of FIG. 6A, in accordance with some embodiments. In some aspects, FFE 600A uses CK0 based on timing diagram 640, CK90 based on timing diagram 642, CK180 based on timing diagram 644, and full-rate data sampling based on timing diagram 646. As illustrated in FIG. 6C, Vin[0] and Vin[1] are valid when CK0 and CK90 are both high. Additionally, Vim[0]=Vin[0]−b₋₁Vin[1] is computed when Vin[0] and Vin[1] are validly sampled.

FIG. 6D is a timing diagram 600D of FFE slice 270 of the FFE of FIG. 6A, in accordance with some embodiments. In some aspects, FFE 600A uses CK270 based on timing diagram 648, CK0 based on timing diagram 650, CK90 based on timing diagram 652, and full-rate data sampling based on timing diagram 654. As illustrated in FIG. 6D, Vim[−1], which is the intermediate output of slice 270, is validly sampled at the rising edge of CK90 and held while CK90 is high. Both Vin[−1] and Vin[0] are valid when CK270 and CK0 are both high. Additionally, Vim[−1]=Vin[−1]−b₋₁Vin[0] is computed when Vin[−1] and Vin[0] are validly sampled.

FIG. 6E is a timing diagram 600E of the FFE of FIG. 6A, in accordance with some embodiments. In some aspects, FFE 600A uses CK90 based on timing diagram 656 and CK180 based on timing diagram 658. As illustrated in FIG. 6E, Vim[−1] and Vim[0] are valid when both CK90 and CK180 are high. Additionally, Vout[0]=Vim[0]−b₁Vim[−1]=Vin[0]−b₋₁Vin[1]−b₁(Vin[−1]−b₋₁Vin[0])=(1+b₁b₋₁)Vin[0]−b₋₁Vin[1]−b₁Vin[−1] is computed when both Vim[0] and Vim[1] are validly sampled.

FIGS. 6A-6E are associated with a 3-tap quarter-rate FFE (1-pre and 1-post cursor), using 25% duty-cycled clocks and their complementary phases. The proposed implementation for H_{eq}(z)=−a₋₁z+1−a₁z⁻¹ is by the cascade of two two-tap FFEs, H_{eq1}(z)=−b₋₁z+1 and H_{eq2}(z)=1−b₁z⁻¹ (FIG. 6A), each of which uses 4-phase 50% duty-cycled clocks. In some aspects, the cascade H_{eq1}(z) H_{eq2}(z) can be made equal to the desired H_{eq}(z) by an appropriate choice of coefficients b₋₁ and b₁, as long as |a₋₁a₁|<0.25. As long as the constraint |a₋₁a₁|<0.25 is met, a cascade of two stages of two-tap equalizers (FIG. 6A) can be used to replace the single-stage three-tap equalizer described by H_{eq}(z) (e.g., FIG. 5A).

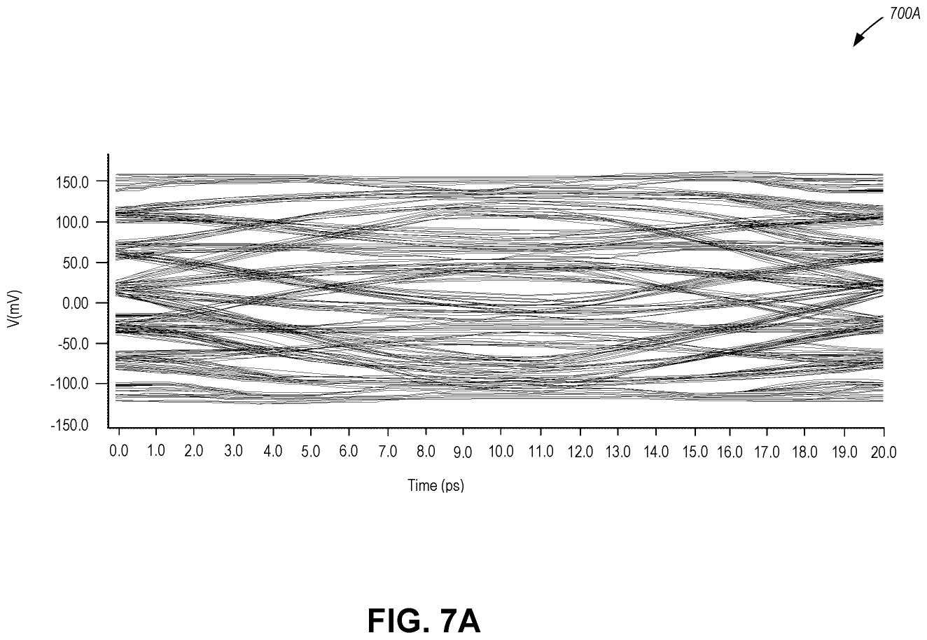

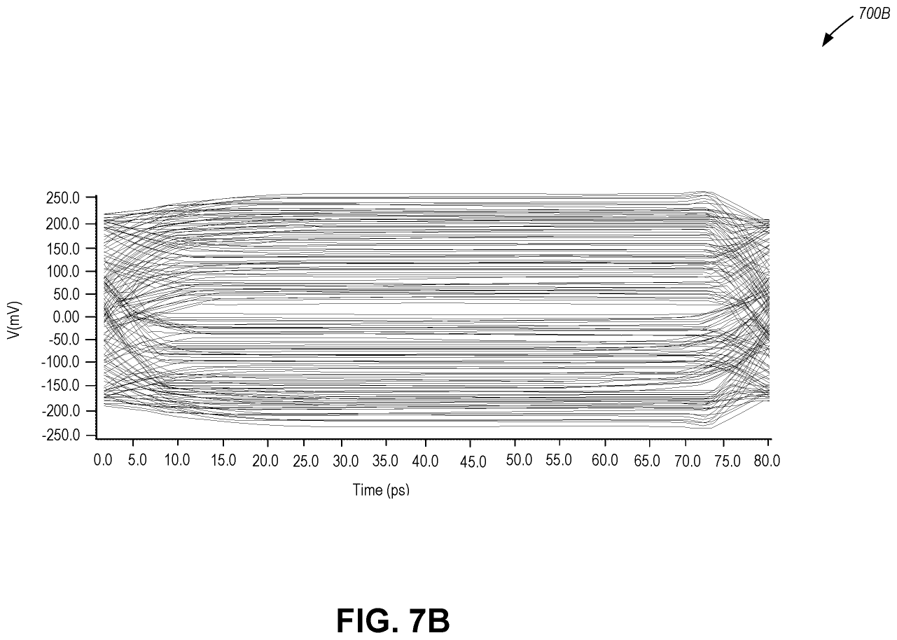

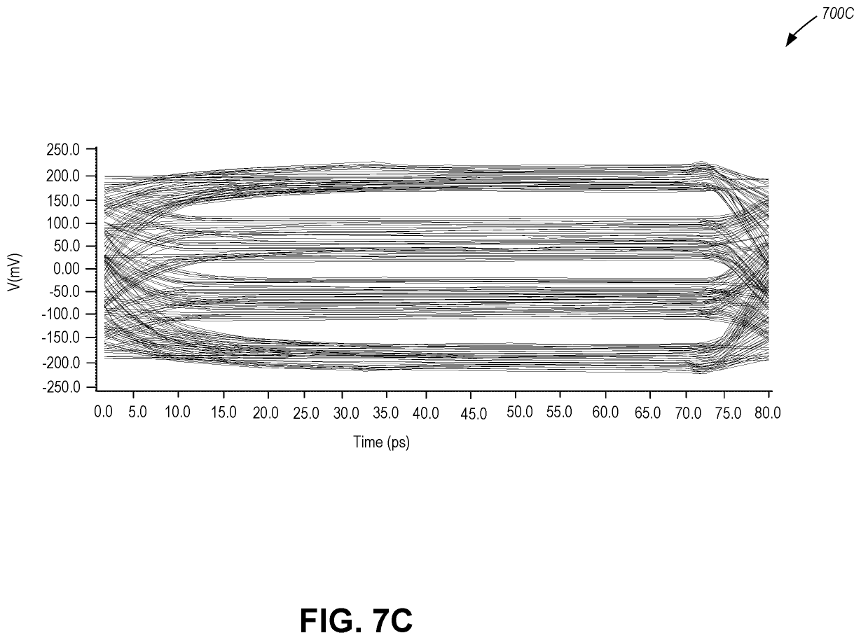

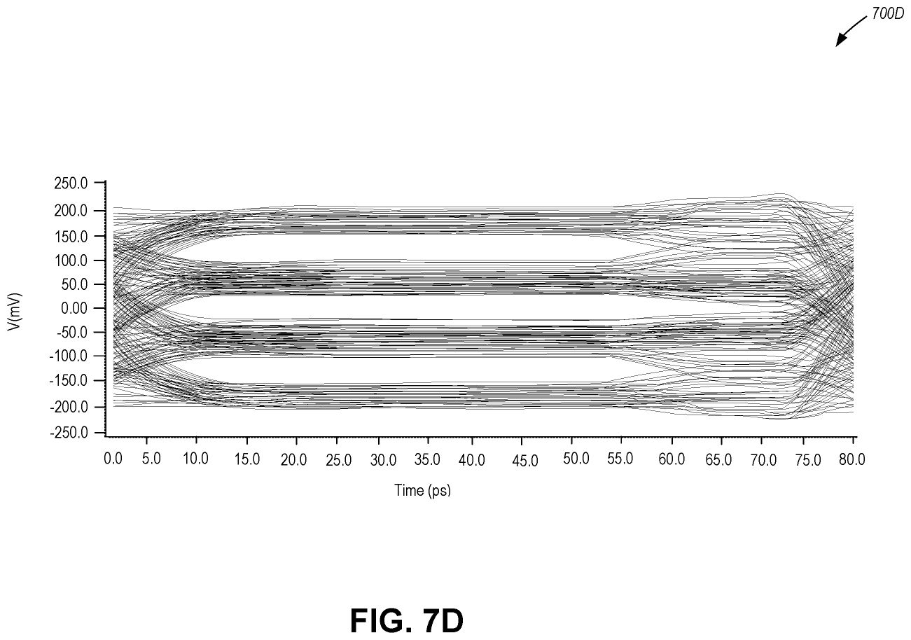

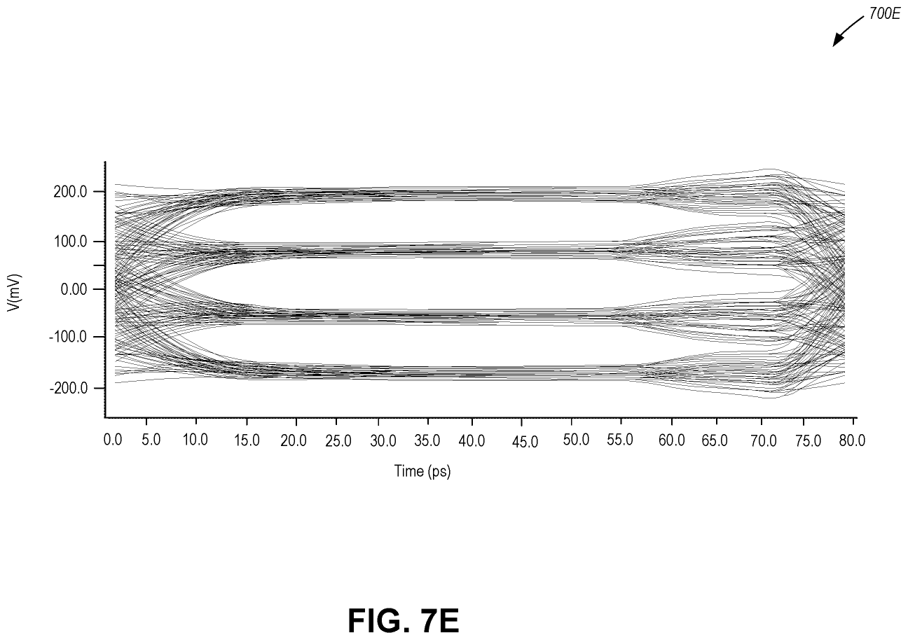

FIGS. 7A-7E show example simulation results demonstrating the efficacy of the disclosed FFE techniques.

FIG. 7A is a graph 700A of unequalized 100 Gb/s PAM4 eye at a full rate associated with simulation results using the disclosed techniques.

FIG. 7B is a graph 700B of unequalized 100 Gb/s PAM4 eye at a quarter rate associated with simulation results using the disclosed techniques.

FIG. 7C is a graph 700C of equalized 100 Gb/s PAM4 eye at a quarter-rate with pre-cursor equalization [−0.13 1] associated with simulation results using the disclosed techniques.

FIG. 7D is a graph 700D of equalized 100 Gb/s PAM4 eye at quarter-rate with post-cursor equalization [1 −0.15] associated with simulation results using the disclosed techniques.

FIG. 7E is a graph 700E of equalized 100 Gb/s PAM4 output eye at quarter-rate with the 3-tap quarter-rate equalizer implemented as a cascade of the pre-cursor [−0.13 1] and post-cursor equalizer [1 −0.15] associated with simulation results using the disclosed techniques.

FIG. 7A shows the 100 Gb/s PAM4 eye diagram at the output of an optical receiver front-end. The eye is closed due to the bandwidth impairments of the receiver front-end and the optical devices. FIG. 7B shows the unequalized PAM4 eye diagram at a quarter rate. The quarter-rate eye diagrams in FIGS. 7C and 7D illustrate that using only a 2-tap pre-cursor or a 2-tap post-cursor equalizer can partially open up the eye. The quarter-rate eye diagram in FIG. 7E shows the efficacy of the proposed 3-tap equalizer to open up the eye.

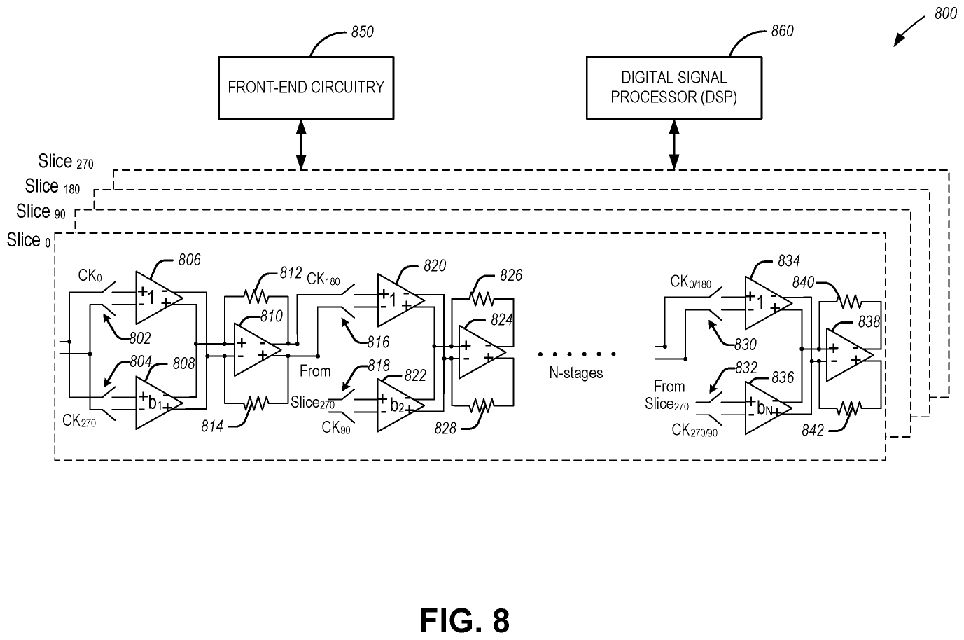

The disclosed FFE-related techniques can be extended to any (N+1)-tap post-cursor equalizer of the form H_{equalizer}(z)=1+a₁z⁻¹+a₂z⁻²+ . . . a_{N}z^{-N}. This may be implemented by a cascade of N-stages of 2-tap equalizers (e.g., as illustrated in FIG. 8) of the form (1+b₁z⁻¹)(1+b₂z⁻¹) . . . (1+b_{N}z⁻¹) using 50% duty-cycled 1/4 rate clocks, instead of using 2N+2 phases of a 1/(2N+2) sub-rate clock. The cascaded implementation is possible as long as there exists a real solution to the value of tap strengths b₁ through b_{N}, which makes the cascaded response equal to H_{equalizer}(z). In other words, such an implementation using a cascade of 2-tap equalizers is possible as long as the polynomial H_{equalizer}(z) has real roots in z. Note that while FIG. 8 shows the equalizer for an (N+1)-tap post-cursor equalizer, the disclosed techniques can be extended to an equalizer with both pre-cursor and post-cursor taps as long as the polynomial describing the equalizer has real roots.

FIG. 8 is a diagram of (N+1)-tap post-cursor FFE 800 using a cascade of N 2-tap post-cursor FFEs, in accordance with some embodiments. Referring to FIG. 8, FFE 800 includes a cascade of N 2-tap post cursor FFEs in four FFE slices, referenced in FIG. 8 as slice 0, slice 90, slice 180, and slice 270.

Slice 0 includes a cascade of 2-tap post-cursor FFEs. For example, the first post-cursor FFE is formed by a set of sample and hold circuits 802 coupled to a differential inverter 806, a set of sample and hold circuits 804 coupled to a differential inverter 808, and differential inverter 810 coupled to resistors 812 and 814. The second post-cursor FFE is formed by a set of sample and hold circuits 816 coupled to a differential inverter 820, a set of sample and hold circuits 818 coupled to a differential inverter 822, and differential inverter 824 coupled to resistors 826 and 828. The Nth post-cursor FFE is formed by a set of sample and hold circuits 830 coupled to a differential inverter 834, a set of sample and hold circuits 832 coupled to a differential inverter 836, and differential inverter 838 coupled to resistors 840 and 842.

In some aspects, slice 90, slice 180, and slice 270 of FFE 800 have the same configuration (components) as slice 0. However, each of the slices can be configured to sample at different times based on different clock phase signals.

In some aspects, even if the polynomial H_{equalizer}(z) does not have all real roots, its non-real roots will occur in complex conjugate pairs. In such a case, H_{equalizer}(z) may be factorized as the product of polynomials of the form (1+bₖz⁻¹) and (1+b₁z⁻¹+bₘz⁻²), where bₖ, b₁ and bₘ are real numbers. That is, in such a case, H_{equalizer}(z) may be implemented as a cascade of three-tap equalizers.

In some aspects, a two-tap equalizer can be treated as a special case of a 3-tap equalizer with one of the taps set to 0. Three-tap equalizers may be realized either using 4-phase clocks with 25% duty-cycle or 4-phase sine-wave clocks (e.g., generated by resonant system such as LC-VCO or resonant clock distribution), which approximate a 25% duty-cycled clock when biased appropriately or using 6-phase clocks with 50% duty-cycle at 1/6^{th} rate.

In some aspects, the disclosed techniques can be used to configure an inverter-based equalizer (e.g., using a Cherry Hooper design for current summing), which is more broadband than conventional differential pair-based current-summing equalizers, with its output DC common mode being independent of tap strength.

In some aspects, the disclosed techniques can be used to configure an (N+1)-tap RX FFE using a cascade of N 2-tap equalizers, as long as the polynomial describing the (N+1)-tap equalizer has all real roots. The case of a quarter-rate 3-tap equalizer was discussed above using a cascade of two 2-tap equalizers. Such an implementation needs only 4 phases of a 1/4^{th} rate clock as opposed to a conventional implementation, which needs 2N (or 6 for 3-tap FFE) phases of a 1/2N (or 1/6 for 3-tap FFE) rate clock.

In some aspects, even if the polynomial describing the equalizer does not have all real roots, it can be implemented as a cascade of several stages of 3-tap equalizers.

In some aspects, the disclosed techniques can be used to configure one or more FFEs used in a signal processing system or apparatus, including a receiver, transmitter, transceiver, and so forth. For example, and as illustrated in FIG. 8, the disclosed FFE can be coupled to a front-end circuitry 850 and a digital signal processor (DSP) 860 or any other circuitry in a signal processing chain.

In some aspects, the disclosed FFEs can be configured to perform offset cancellation at different stages of the cascaded FFEs by placing a current sink/source at the output of each FFE stage in the cascade to perform offset cancellation for the cascaded FFE.

In some aspects, the use of dummy switches largely mitigates the clock feedthrough effects. Kickback effects can be negligible if the system is designed with a reasonably high gain before the sampling happens.

In some aspects, the disclosed FFE techniques can address FFE mismatch by having tunable feedback resistor banks in the Cherry-Hooper stages to tune the gain in the FFE in case of mismatch. Additionally, a finer tuning control may be implemented while building the tunable inverter banks used to equalize the pre-cursor/post-cursor in every stage.

In some aspects, FFE 800 (or any of the other FFEs discussed herein) can be configured (e.g., implemented) as part of a system on chip (SoC). The SoC can include an integrated circuit (IC). The IC can include two or more of the components illustrated in FIG. 8 (e.g., two or more of the front-end circuitry 850, the DSP 860, and the components of FFE 800). In some aspects, the SoC includes at least one connector, where the IC is coupled to the connector, and the IC includes the FFE circuitry. In some aspects, the connector conforms with at least one of Universal Serial Bus (USB), High-Definition Multimedia Interface (HDMI), Thunderbolt, Peripheral Component Interconnect Express (PCIe), and Ethernet specifications.

In some aspects, the front-end circuitry 850 can include an antenna to receive the input signal.

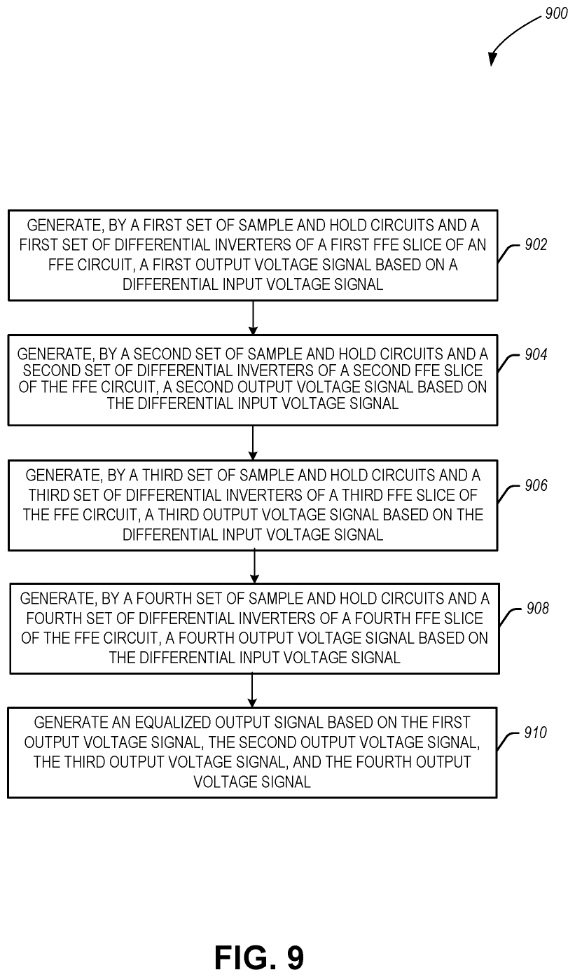

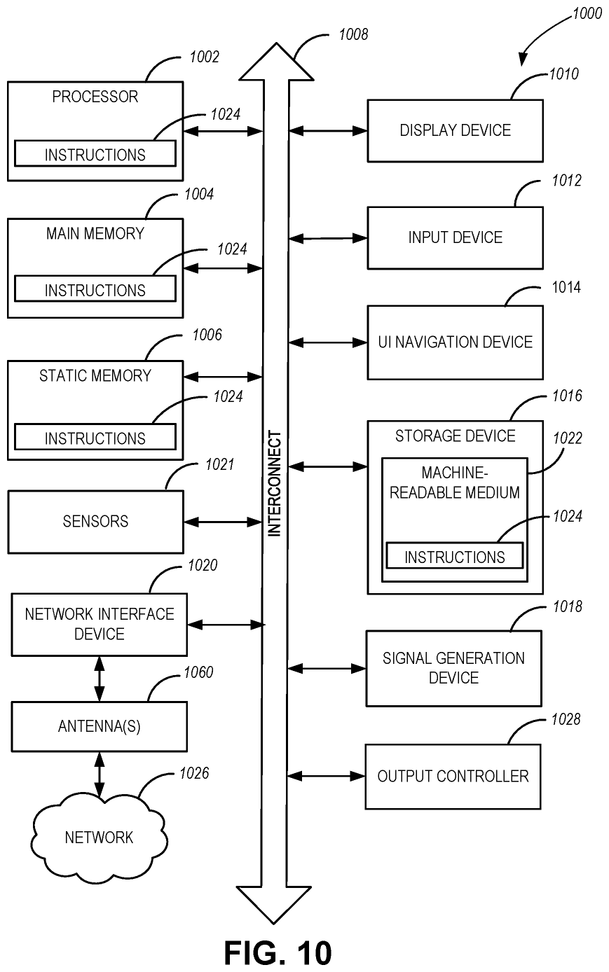

FIG. 9 is a flow diagram of an example method 900 for performing feedforward equalization, in accordance with some embodiments. Referring to FIG. 9, method 900 includes operations 902, 904, 906, 908, and 910, which may be executed by an FFE circuit, an embedded controller, a receiver circuit, a transceiver circuit, or another processor of a computing device (e.g., hardware processor 1002 of machine 1000 illustrated in FIG. 10, which can include one or more of the circuits discussed in connection with FIGS. 1-8). In some embodiments, one or more of the circuits discussed in connection with FIGS. 1-8 can perform the functionalities listed in FIG. 9, as well as in the examples listed below.

The example operations below can be performed by any of the FFE slices discussed in connection with FIGS. 3A-8.

At operation 902, a first set of sample and hold circuits and a first set of differential inverters of a first feedforward equalizer (FFE) slice of an FFE circuit are used to generate a first output voltage signal based on a differential input voltage signal.

At operation 904, a second set of sample and hold circuits and a second set of differential inverters of a second FFE slice of the FFE circuit are used to generate a second output voltage signal based on the differential input voltage signal.

At operation 906, a third set of sample and hold circuits and a third set of differential inverters of a third FFE slice of the FFE circuit are used to generate a third output voltage signal based on the differential input voltage signal.

At operation 908, a fourth set of sample and hold circuits and a fourth set of differential inverters of a fourth FFE slice of the FFE circuit are used to generate a fourth output voltage signal based on the differential input voltage signal.

At operation 910, an equalized output signal is generated based on the first output voltage signal, the second output voltage signal, the third output voltage signal, and the fourth output voltage signal.

FIG. 10 illustrates a block diagram of an example machine 1000 upon which any one or more of the techniques (e.g., methodologies) discussed herein may perform. In alternative embodiments, the machine 1000 may operate as a standalone device or may be connected (e.g., networked) to other machines. In a networked deployment, machine 1000 may operate in the capacity of a server machine, a client machine, or both in server-client network environments. In an example, machine 1000 may function as a peer machine in a peer-to-peer (P2P) (or other distributed) network environment. The machine 1000 may be a personal computer (PC), a tablet PC, a set-top box (STB), a personal digital assistant (PDA), a portable communications device, a mobile telephone, a smartphone, a web appliance, a network router, switch or bridge, or any other computing device capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations. The terms “machine,” “computing device,” and “computer system” are used interchangeably.

Machine (e.g., computer system) 1000 may include a hardware processor 1002 (e.g., a central processing unit (CPU), a graphics processing unit (GPU), a hardware processor core, or any combination thereof), a main memory 1004, and a static memory 1006, some or all of which may communicate with each other via an interlink (e.g., bus) 1008. In some aspects, the main memory 1004, the static memory 1006, or any other type of memory (including cache memory) used by machine 1000 can be configured based on the disclosed techniques or can implement the disclosed memory devices.

Specific examples of main memory 1004 include Random Access Memory (RAM) and semiconductor memory devices, which may include, in some embodiments, storage locations in semiconductors such as registers. Specific examples of static memory 1006 include non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; RAM; and CD-ROM and DVD-ROM disks.

Machine 1000 may further include a display device 1010, an input device 1012 (e.g., a keyboard), and a user interface (UI) navigation device 1014 (e.g., a mouse). In an example, the display device 1010, the input device 1012, and the UI navigation device 1014 may be a touchscreen display. The machine 1000 may additionally include a storage device (e.g., drive unit or another mass storage device) 1016, a signal generation device 1018 (e.g., a speaker), a network interface device 1020, and one or more sensors 1021, such as a global positioning system (GPS) sensor, compass, accelerometer, or other sensors. The machine 1000 may include an output controller 1028, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.). In some embodiments, the hardware processor 1002 and/or instructions 1024 may comprise processing circuitry and/or transceiver circuitry.

The storage device 1016 may include a machine-readable medium 1022 on which one or more sets of data structures or instructions 1024 (e.g., software) embodying or utilized by any one or more of the techniques or functions described herein can be stored. Instructions 1024 may also reside, completely or at least partially, within the main memory 1004, within static memory 1006, or the hardware processor 1002 during execution thereof by the machine 1000. In an example, one or any combination of the hardware processor 1002, the main memory 1004, the static memory 1006, or the storage device 1016 may constitute machine-readable media.

Specific examples of machine-readable media may include non-volatile memory, such as semiconductor memory devices (e.g., EPROM or EEPROM) and flash memory devices; magnetic disks, such as internal hard disks and removable disks; magneto-optical disks; RAM; and CD-ROM and DVD-ROM disks.

While the machine-readable medium 1022 is illustrated as a single medium, the term “machine-readable medium” may include a single medium or multiple media (e.g., a centralized or distributed database and/or associated caches and servers) configured to store instructions 1024.

An apparatus of machine 1000 may be one or more of a hardware processor 1002 (e.g., a central processing unit (CPU), a graphics processing unit (GPU), a hardware processor core, or any combination thereof), a main memory 1004 and a static memory 1006, one or more sensors 1021, a network interface device 1020, one or more antennas 1060, a display device 1010, an input device 1012, a UI navigation device 1014, a storage device 1016, instructions 1024, a signal generation device 1018, and an output controller 1028. The apparatus may be configured to perform one or more of the methods and/or operations disclosed herein. The apparatus may be intended as a component of machine 1000 to perform one or more of the methods and/or operations disclosed herein and/or to perform a portion of one or more of the methods and/or operations disclosed herein. In some embodiments, the apparatus may include a pin or other means to receive power. In some embodiments, the apparatus may include power conditioning hardware.

The term “machine-readable medium” may include any medium that is capable of storing, encoding, or carrying instructions for execution by machine 1000 and that causes machine 1000 to perform any one or more of the techniques of the present disclosure, or that is capable of storing, encoding, or carrying data structures used by or associated with such instructions. Non-limiting machine-readable medium examples may include solid-state memories and optical and magnetic media. Specific examples of machine-readable media may include non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); and CD-ROM and DVD-ROM disks. In some examples, machine-readable media may include non-transitory machine-readable media. In some examples, machine-readable media may include machine-readable media that is not a transitory propagating signal.

The instructions 1024 may further be transmitted or received over a communications network 1026 using a transmission medium via the network interface device 1020 utilizing any one of several transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, a Long Term Evolution (LTE) family of standards, a Universal Mobile Telecommunications System (UMTS) family of standards, peer-to-peer (P2P) networks, among others.

In an example, the network interface device 1020 may include one or more physical jacks (e.g., Ethernet, coaxial, or phone jacks) or one or more antennas to connect to the communications network 1026. In an example, the network interface device 1020 may include one or more antennas 1060 to wirelessly communicate using at least one single-input multiple-output (SIMO), multiple-input multiple-output (MIMO), or multiple-input single-output (MISO) techniques. In some examples, the network interface device 1020 may wirelessly communicate using multiple-user MIMO techniques. The term “transmission medium” shall be taken to include any intangible medium that can store, encode, or carry instructions for execution by the machine 1000 and includes digital or analog communications signals or other intangible media to facilitate communication of such software.

Examples, as described herein, may include, or may operate on, logic or several components, modules, or mechanisms. Modules are tangible entities (e.g., hardware) capable of performing specified operations and may be configured or arranged in a particular manner. In an example, circuits may be arranged (e.g., internally or concerning external entities such as other circuits) in a specified manner as a module. In an example, the whole or part of one or more computer systems (e.g., a standalone, client, or server computer system) or one or more hardware processors may be configured by firmware or software (e.g., instructions, an application portion, or an application) as a module that operates to perform specified operations. In an example, the software may reside on a machine-readable medium. In an example, the software, when executed by the underlying hardware of the module, causes the hardware to perform the specified operations.

Accordingly, the term “module” is understood to encompass a tangible entity, be that an entity that is physically constructed, specifically configured (e.g., hardwired), or temporarily (e.g., transitorily) configured (e.g., programmed) to operate in a specified manner or to perform part, all, or any operation described herein. Considering examples in which modules are temporarily configured, each of the modules need not be instantiated at any one moment in time. For example, where the modules comprise a general-purpose hardware processor configured using the software, the general-purpose hardware processor may be configured as respective different modules at separate times. The software may accordingly configure a hardware processor, for example, to constitute a particular module at one instance of time and to constitute a different module at a different instance of time.

Some embodiments may be implemented fully or partially in software and/or firmware. This software and/or firmware may take the form of instructions contained in or on a non-transitory computer-readable storage medium. Those instructions may then be read and executed by one or more processors to enable the performance of the operations described herein. The instructions may be in any suitable form, such as but not limited to source code, compiled code, interpreted code, executable code, static code, dynamic code, and the like. Such a computer-readable medium may include any tangible non-transitory medium for storing information in a form readable by one or more computers, such as but not limited to read-only memory (ROM), random access memory (RAM), magnetic disk storage media, optical storage media, flash memory, etc.

The above-detailed description includes references to the accompanying drawings, which form a part of the detailed description. The drawings show, by way of illustration, specific embodiments that may be practiced. These embodiments are also referred to herein as “examples.” Such examples may include elements in addition to those shown or described. However, examples that include the elements shown or described are also contemplated. Moreover, also contemplated are examples using any combination or permutation of those elements shown or described (or one or more aspects thereof), either with respect to a particular example (or one or more aspects thereof) or with respect to other examples (or one or more aspects thereof) shown or described herein.

Publications, patents, and patent documents referred to in this document are incorporated by reference herein in their entirety, as though individually incorporated by reference. In the event of inconsistent usage between this document and those documents so incorporated by reference, the usage in the incorporated reference(s) is supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc., are used merely as labels and are not intended to suggest a numerical order for their objects.

The embodiments as described above may be implemented in various hardware configurations that may include a processor for executing instructions that perform the techniques described. Such instructions may be contained in a machine-readable medium such as a suitable storage medium or a memory or other processor-executable medium.

The embodiments as described herein may be implemented in several environments, such as part of a system on chip, a set of intercommunicating functional blocks, or similar, although the scope of the disclosure is not limited in this respect.

Described implementations of the subject matter can include one or more features, alone or in combination, as illustrated below by way of examples.

Example 1 is a feedforward equalizer (FFE) circuit comprising a first sample and hold circuit including an input terminal coupled to a first differential input signal; a second sample and hold circuit including an input terminal coupled to a second differential input signal; a first differential inverter including a first input terminal coupled to an output terminal of the first sample and hold circuit, a second input terminal coupled to an output terminal of the second sample and hold circuit, a first output terminal, and a second output terminal; and a second differential inverter including a first output terminal coupled to the second output terminal of the first differential inverter and a second output terminal coupled to the first output terminal of the first differential inverter.

In Example 2, the subject matter of Example 1 includes a third sample and hold circuit, including an input terminal coupled to the first differential input signal, and a fourth sample and hold circuit, including an input terminal coupled to the second differential input signal.

In Example 3, the subject matter of Example 2 includes subject matter where the second differential inverter includes a first input terminal coupled to an output terminal of the third sample and hold circuit and a second input terminal coupled to an output terminal of the fourth sample and hold circuit.

In Example 4, the subject matter of Examples 1-3 includes a third differential inverter including a first input terminal coupled to the second output terminal of the first differential inverter and the first output terminal of the second differential inverter; and a second input terminal coupled to the first output terminal of the first differential inverter and the second output terminal of the second differential inverter.

In Example 5, the subject matter of Example 4 includes a first resistor coupled to a first output terminal and the first input terminal of the third differential inverter.

In Example 6, the subject matter of Example 5 includes a second resistor coupled to a second output terminal and the second input terminal of the third differential inverter.

In Example 7, the subject matter of Examples 1-6 includes subject matter where the first sample and hold circuit further comprises a first N-channel Metal-Oxide-Semiconductor (NMOS) transistor and a second NMOS transistor, wherein a source of the first NMOS transistor is coupled to a drain of the second NMOS transistor.

In Example 8, the subject matter of Example 7 includes subject matter where the first sample and hold circuit further comprises a first P-channel Metal-Oxide-Semiconductor (PMOS) transistor and a second PMOS transistor, wherein a drain of the first PMOS transistor is coupled to a source of the second NMOS transistor, wherein a drain of the second PMOS transistor and a source of the second NMOS transistor are coupled to the input terminal of the first differential inverter, and wherein a source of the first PMOS transistor and a drain of the first NMOS transistor are coupled to the first differential input signal.

In Example 9, the subject matter of Example 8 includes subject matter where a gate of the first PMOS transistor and a gate of the second NMOS transistor are coupled to a first clock signal, wherein a gate of the second PMOS transistor and a gate of the first NMOS transistor are coupled to a second clock signal, and wherein the first clock signal and the second clock signal are offset with each other by a half period.

In Example 10, the subject matter of Examples 1-9 includes one or more interconnects coupling two or more of the first sample and hold circuit, the second sample and hold circuit, the first differential inverter, and the second differential inverter.

Example 11 is a receiver apparatus comprising front-end circuitry configured to convert an input signal into a digital signal; feedforward equalizer (FFE) circuitry coupled to the front-end circuitry, the FFE circuitry comprising a first FFE circuit configured to generate a first equalized signal based on a pre-cursor signal associated with the digital signal; and a second FFE circuit cascaded with the first FFE circuit, the second FFE circuit to generate a second equalized signal based on a post-cursor signal associated with the digital signal; and a digital signal processor (DSP) to generate an output signal based on at least one of the first equalized signal and the second equalized signal.

In Example 12, the subject matter of Example 11 includes an antenna coupled to the front-end circuitry, the antenna to receive the input signal.

In Example 13, the subject matter of Examples 11-12 includes subject matter where the first FFE circuit comprises a first sample and hold circuit to receive a first differential input signal corresponding to the digital signal and a second sample and hold circuit to receive a second differential input signal corresponding to the digital signal.

In Example 14, the subject matter of Example 13 includes subject matter where the first FFE circuit comprises a third sample and hold circuit to receive the first differential input signal and a fourth sample and hold circuit to receive the second differential input signal.

In Example 15, the subject matter of Example 14 includes subject matter where the first FFE circuit comprises: a first differential inverter coupled to the first sample and hold circuit and the second sample and hold circuit; a second differential inverter coupled to the third sample and hold circuit and the fourth sample and hold circuit; and a third differential inverter coupled to the first differential inverter and the second differential inverter, the third differential inverter to generate the first equalized signal.

In Example 16, the subject matter of Example 15 includes subject matter where the second FFE circuit comprises a fifth sample and hold circuit to receive a third differential input signal corresponding to the first equalized signal; a sixth sample and hold circuit to receive a fourth differential input signal corresponding to the first equalized signal; a seventh sample and hold circuit to receive a fifth differential input signal associated with the digital signal; and an eighth sample and hold circuit to receive a sixth differential input signal associated with the digital signal.

In Example 17, the subject matter of Example 16 includes subject matter where the second FFE circuit comprises a fourth differential inverter coupled to the fifth sample and hold circuit and the sixth sample and hold circuit; a fifth differential inverter coupled to the seventh sample and hold circuit and the eighth sample and hold circuit; and a sixth differential inverter coupled to the fourth differential inverter and the fifth differential inverter, the sixth differential inverter to generate the second equalized signal based on current signals generated by the fourth differential inverter and the fifth differential inverter.

In Example 18, the subject matter of Examples 16-17 includes subject matter where the first sample and hold circuit and the second sample and hold circuit are clocked by a first clock signal, and the third sample and hold circuit and the fourth sample and hold circuit are clocked by a second clock signal, the second clock signal being a quarter period offset from the first clock signal.

In Example 19, the subject matter of Example 18 includes subject matter where: the seventh sample and hold circuit and the eighth sample and hold circuit are clocked by the first clock signal, and the fifth sample and hold circuit and the sixth sample and hold circuit are clocked by a third clock signal, the third clock signal being a half period offset from the first clock signal.

Example 20 is a method comprising: generating, by a first set of sample and hold circuits and a first set of differential inverters of a first feedforward equalizer (FFE) slice of an FFE circuit, a first output voltage signal based on a differential input voltage signal; generating, by a second set of sample and hold circuits and a second set of differential inverters of a second FFE slice of the FFE circuit, a second output voltage signal based on the differential input voltage signal; generating, by a third set of sample and hold circuits and a third set of differential inverters of a third FFE slice of the FFE circuit, a third output voltage signal based on the differential input voltage signal; generating, by a fourth set of sample and hold circuits and a fourth set of differential inverters of a fourth FFE slice of the FFE circuit, a fourth output voltage signal based on the differential input voltage signal; and generating an equalized output signal based on the first output voltage signal, the second output voltage signal, the third output voltage signal, and the fourth output voltage signal.

Example 21 is at least one machine-readable medium including instructions that, when executed by processing circuitry, cause the processing circuitry to perform operations to implement any of Examples 1-20.

Example 22 is an apparatus comprising means to implement any of Examples 1-20.

Example 23 is a system to implement any of Examples 1-20.

Example 24 is a method to implement any of Examples 1-20.

The above description is intended to be illustrative and not restrictive. For example, the above-described examples (or one or more aspects thereof) may be used in combination with others. Other embodiments may be used, such as by one of ordinary skill in the art upon reviewing the above description. The abstract is to allow the reader to ascertain the nature of the technical disclosure quickly. It is submitted with the understanding that it will not be used to interpret or limit the scope or meaning of the claims. Also, in the above Detailed Description, various features may be grouped to streamline the disclosure. However, the claims may not set forth every feature disclosed herein as embodiments may feature a subset of said features. Further, embodiments may include fewer features than those disclosed in a particular example. Thus, the following claims are hereby incorporated into the Detailed Description, with a claim standing on its own as a separate embodiment. The scope of the embodiments disclosed herein is to be determined regarding the appended claims, along with the full scope of equivalents to which such claims are entitled.

What is claimed is:

1. A feedforward equalizer (FFE) circuit comprising:
a first sample and hold circuit including an input terminal coupled to a first differential input signal;
a second sample and hold circuit including an input terminal coupled to a second differential input signal;
a first differential inverter including a first input terminal coupled to an output terminal of the first sample and hold circuit, a second input terminal coupled to an output terminal of the second sample and hold circuit, a first output terminal, and a second output terminal; and
a second differential inverter including a first output terminal coupled to the second output terminal of the first differential inverter and a second output terminal coupled to the first output terminal of the first differential inverter.

2. The FFE circuit of claim 1, further comprising:
a third sample and hold circuit including an input terminal coupled to the first differential input signal; and
a fourth sample and hold circuit including an input terminal coupled to the second differential input signal.

3. The FFE circuit of claim 2, wherein the second differential inverter includes a first input terminal coupled to an output terminal of the third sample and hold circuit and a second input terminal coupled to an output terminal of the fourth sample and hold circuit.

4. The FFE circuit of claim 1, further comprising:
a third differential inverter including:
a first input terminal coupled to the second output terminal of the first differential inverter and the first output terminal of the second differential inverter; and
a second input terminal coupled to the first output terminal of the first differential inverter and the second output terminal of the second differential inverter.

5. The FFE circuit of claim 4, further comprising:
a first resistor coupled to a first output terminal and the first input terminal of the third differential inverter.

6. The FFE circuit of claim 5, further comprising:
a second resistor coupled to a second output terminal and the second input terminal of the third differential inverter.

7. The FFE circuit of claim 1, wherein the first sample and hold circuit further comprises:
a first N-channel Metal-Oxide-Semiconductor (NMOS) transistor; and
a second NMOS transistor, wherein a source of the first NMOS transistor is coupled to a drain of the second NMOS transistor.

8. The FFE circuit of claim 7, wherein the first sample and hold circuit further comprises:
a first P-channel Metal-Oxide-Semiconductor (PMOS) transistor; and
a second PMOS transistor, wherein a drain of the first PMOS transistor is coupled to a source of the second PMOS transistor, wherein a drain of the second PMOS transistor, a source of the second PMOS transistor, and a source of the second NMOS transistor are coupled to the input terminal of the first differential inverter, and wherein a source of the first PMOS transistor and a drain of the first NMOS transistor are coupled to the first differential input signal.

9. The FFE circuit of claim 8, wherein a gate of the first PMOS transistor and a gate of the second NMOS transistor are coupled to a first clock signal, wherein a gate of the second PMOS transistor and a gate of the first NMOS transistor are coupled to a second clock signal, and wherein the first clock signal and the second clock signal are offset with each other by a half period.

10. The FFE circuit of claim 1, wherein the circuit comprises a system on chip (SoC), the SoC including an integrated circuit (IC), the IC including two or more of the first sample and hold circuit, the second sample and hold circuit, the first differential inverter, and the second differential inverter.

11. A receiver apparatus comprising:
front-end circuitry configured to convert an input signal into a digital signal;
feedforward equalizer (FFE) circuitry coupled to the front-end circuitry, the FFE circuitry comprising:
a first FFE circuit configured to generate a first equalized signal based on a pre-cursor signal associated with the digital signal; and
a second FFE circuit cascaded with the first FFE circuit, the second FFE circuit to generate a second equalized signal based on a post-cursor signal associated with the digital signal; and
a digital signal processor (DSP) to generate an output signal based on at least one of the first equalized signal and the second equalized signal.

12. The receiver apparatus of claim 11, further comprising:
an antenna coupled to the front-end circuitry, the antenna to receive the input signal; and
a connector, wherein the receiver apparatus comprises an integrated circuit (IC) coupled to the connector, the IC including the FFE circuitry, and wherein the connector conforms with at least one of Universal Serial Bus (USB), High-Definition Multimedia Interface (HDMI), Thunderbolt, Peripheral Component Interconnect Express (PCIe), and Ethernet specifications.

13. The receiver apparatus of claim 11, wherein the first FFE circuit comprises:
a first sample and hold circuit to receive a first differential input signal corresponding to the digital signal; and
a second sample and hold circuit to receive a second differential input signal corresponding to the digital signal.

14. The receiver apparatus of claim 13, wherein the first FFE circuit comprises:
a third sample and hold circuit to receive the first differential input signal; and
a fourth sample and hold circuit to receive the second differential input signal.

15. The receiver apparatus of claim 14, wherein the first FFE circuit comprises:
a first differential inverter coupled to the first sample and hold circuit and the second sample and hold circuit;
a second differential inverter coupled to the third sample and hold circuit and the fourth sample and hold circuit; and
a third differential inverter coupled to the first differential inverter and the second differential inverter, the third differential inverter to generate the first equalized signal.

16. The receiver apparatus of claim 15, wherein the second FFE circuit comprises:
a fifth sample and hold circuit to receive a third differential input signal corresponding to the first equalized signal;
a sixth sample and hold circuit to receive a fourth differential input signal corresponding to the first equalized signal;
a seventh sample and hold circuit to receive a fifth differential input signal associated with the digital signal; and
an eighth sample and hold circuit to receive a sixth differential input signal associated with the digital signal.

17. The receiver apparatus of claim 16, wherein the second FFE circuit comprises:
a fourth differential inverter coupled to the fifth sample and hold circuit and the sixth sample and hold circuit;
a fifth differential inverter coupled to the seventh sample and hold circuit and the eighth sample and hold circuit; and
a sixth differential inverter coupled to the fourth differential inverter and the fifth differential inverter, the sixth differential inverter to generate the second equalized signal based on current signals generated by the fourth differential inverter and the fifth differential inverter.

18. The receiver apparatus of claim 16, wherein:
the first sample and hold circuit and the second sample and hold circuit are clocked by a first clock signal;
the third sample and hold circuit and the fourth sample and hold circuit are clocked by a second clock signal, the second clock signal being a quarter period offset from the first clock signal;
the seventh sample and hold circuit and the eighth sample and hold circuit are clocked by the first clock signal; and
the fifth sample and hold circuit and the sixth sample and hold circuit are clocked by a third clock signal, the third clock signal being a half period offset from the first clock signal.

19. The receiver apparatus of claim 18, wherein the receiver apparatus comprises a system on chip (SoC), the SoC including an integrated circuit (IC), the IC including two or more of the front-end circuitry, the FFE circuitry, and the DSP.

20. A method comprising:
generating, by a first set of sample and hold circuits and a first set of differential inverters of a first feedforward equalizer (FFE) slice of an FFE circuit, a first output voltage signal based on a differential input voltage signal;
generating, by a second set of sample and hold circuits and a second set of differential inverters of a second FFE slice of the FFE circuit, a second output voltage signal based on the differential input voltage signal;
generating, by a third set of sample and hold circuits and a third set of differential inverters of a third FFE slice of the FFE circuit, a third output voltage signal based on the differential input voltage signal;
generating, by a fourth set of sample and hold circuits and a fourth set of differential inverters of a fourth FFE slice of the FFE circuit, a fourth output voltage signal based on the differential input voltage signal; and
generating an equalized output signal based on the first output voltage signal, the second output voltage signal, the third output voltage signal, and the fourth output voltage signal.
